(19) United States
(12) Patent Application Publication
(10) Pub. No.: US 2010/0201561 A1
(43) Pub. Date: Aug. 12, 2010

(54) GONIOMETRIC SYSTEM COMPRISING NETWORKS OF MINI DOPPLER SENSORS FOR PERIMETER SURVEILLANCE

(75) Inventors: Francois Dhondt, Villiers Sur Orge (FR); Jean-Philippe Brunet, Les Ulis (FR); Anne Cognieux, Les Ulis (FR)

Correspondence Address: DARBY & DARBY P.C., P.O. BOX 770, Church Street Station, New York, NY, 10008-0770, US

(73) Assignee: THALES, NEUILLY SUR SEINE (FR)

(21) Appl. No.: 12/519,300

(22) PCT Filed: Dec. 13, 2007
(86) PCT No.: PCT/EP07/63915

§ 371 Date: Feb. 16, 2010

(30) Foreign Application Priority Data
Dec. 15, 2006 (FR) 06/10958

(51) Int. Cl. G01S 13/56

(52) U.S. Cl. 342/27

(57) ABSTRACT

The present invention relates to the detection of intruders (human beings, vehicles or animals) in a protected zone and the departure of individuals from this zone. One or more embodiment of the invention relates to a device which includes a plurality of individual standalone electromagnetic sensors placed on the perimeter of the guarded zone so as to substantially cover this perimeter, and a central unit placed close to the perimeter surrounding the guarded zone. Each sensor takes a measurement of the angular position and of the speed of an intruder present in the zone that it covers. These measurements are relayed to the central unit from the sensor having detected the intruder, through a communication network formed by all of the sensors. The central unit processes the data transmitted by the various sensors and periodically determines the position and trajectory of the detected intruders. The invention applies in particular to the guarding of civil and military infrastructures (airports, factories, oil pipelines, gas pipelines, ports, railways etc.) or of private zones (properties, estates).

### CROSS-REFERENCE TO PRIOR APPLICATION

This is a U.S. National Phase Application under 35 U.S.C. §371 of International Application no. PCT/EP2007/063915, filed Dec. 13, 2007, and claims benefit of French Patent Application No. 06 10958, filed Dec. 15, 2006, both of which are incorporated herein. The International Application was published in French on Jun. 19, 2008 as WO 2008/071780 under PCT Article 21 (2).

### BACKGROUND OF THE INVENTION

1. Field of the Invention

The present invention relates to the general field of security. It relates more particularly to the guarding of civil and military infrastructures (airports, factories, oil pipelines, gas pipelines, ports, railways etc.) and the guarding of private zones (properties, estates), and even of controlled-access or even forbidden zones (zones partially open to the public, military zones, health exclusion zones etc.). It relates yet more particularly to the detection of intruders (human beings, vehicles or animals) and the monitoring of their progress in the protected zone.

2. Prior Art

Currently there are several types of systems for protecting a zone, a perimeter, so as to prevent undesirable intrusions into this zone. From a functional point of view, these systems may be classified into two large categories: systems performing simple detection on the one hand, and the simple detection systems on the one hand and anti-intrusion systems on the other hand.

Amongst the simple detection systems generally used, it is possible to distinguish several categories:
intrusion-detection barriers, mainly infrared barriers and microwave barriers,
camera systems, optical or thermal cameras for example,
movement-detecting systems, seismic or acoustic sensor systems for example.
   Detection barriers are equipment comprising transmitter elements and their operating principle is to detect intrusions by detecting the impairment (microwave barrier) or the breakage (infrared barrier) of the emitted beam resulting therefrom. This type of barrier advantageously makes it possible to delimit a given zone, a rectangular or polygonal zone for example, by placing at the vertices of the polygon appropriate items of equipment which each cover one side of the polygon. The intangible barriers thus formed make it possible to detect an intrusion and to locate the side through which the intrusion into the zone takes place. On the other hand, this type of barrier has many disadvantages amongst which it is possible to cite:
the sensitivity of this type of barrier to climatic conditions, in particular the infrared barriers. A reduction in effectiveness has been observed notably during fog and rain due to the attenuation of the attenuation signal,
the fact that this type of barrier is not very mobile,
the need to install a rather bulky infrastructure (delivery of the signals and the power) in order to implement this type of barrier,
the fact that, with this type of barrier, it is not possible to determine the type of intruder, to identify precisely the location of intrusion or else to follow the trajectory of the intruder after it has passed through the barrier,
also the fact that it is not possible to apply a preventive alert procedure before intrusion, the possible intruder being detected only as it passes through the barrier.
   The camera systems, in particular the systems comprising remotely orientable cameras, have for their part the advantage of allowing the predetection of a possible intruder, the detection of the crossing of the limits of the protected zone and the monitoring of the intruder in the zone. However, they have two major disadvantages. On the one hand, it is necessary to regularly sweep the protected zone and its approaches, then, if a potential intruder is detected, to point the camera in the direction of the intruder. On the other hand, it is necessary either to have an automatic system capable of identifying a potential intruder as an intruder, or to at all times mobilize a human operator in order to examine the screens associated with the cameras and carry out the surveillance.
   The movement-detection systems are, for their part, very sensitive blind systems which make it possible, thanks to the acoustic or mechanical vibrations generated in the protected zone, to detect the movement of intruders of the motorized machine type, of human beings traveling on foot or of animals. However, they are not usually capable of locating the intruder whose movement is detected nor of following the trajectory of the intruder in the zone.

With respect to the simple barriers, the anti-intrusion systems satisfy the desire to prevent or delay the intrusion. These systems include in particular all the types of material barriers of the fence or barbed wire type for example, which can prevent an intrusion or at least slow the intruder's crossing of the limits of the protected zone. They are usually supplemented by simple intrusion-detection means based on the detection of current leakage or on detection of vibration of the fence. Although it forms a usually effective obstacle to intrusion, these systems however do not provide a prewarning nor monitoring of the progress of the intruder. For their installation, they also require relatively costly construction stages.

### DESCRIPTION OF THE INVENTION

One object of the invention is to propose a means for controlling access (entrance and exit) to a given zone; this means making it possible to detect a potential intruder before intrusion, to detect the actual intrusion and the precise location of this intrusion, and finally, after the intrusion, to monitor the intruder in the zone; this means conversely making it possible to detect any movement out of the zone.

Another object of the invention is to propose a means that can be easily deployed in any given zone and that does not require the installation of considerable logistics.

Accordingly, the subject of the invention is a device for detecting movements into a geographic zone or out of this zone, this device including:
a plurality of individual standalone electromagnetic sensors, placed on the perimeter of the guarded zone and arranged so that the zone of the space covered by each detector partially overlaps the zone of the space covered by the adjacent sensors,
a central unit placed close to the perimeter surrounding the guarded zone.
   According to one or more embodiments of the invention, each sensor takes a measurement of the angular position in angle of elevation and relative bearing and of the speed of any intruder present in the zone that it covers. These measurements are relayed to the central unit from the sensor having detected the intruder, by successive transmissions of these measurements from one sensor to the adjacent sensors or, for any sensor sufficiently close to the central unit, from this sensor to the central unit.
   The central unit carries out, on the data transmitted by the various sensors, a process making it possible to determine periodically the position and trajectory of the detected intruders.
   In a particular embodiment, the device may also include individual standalone electromagnetic sensors placed inside the guarded zone and also arranged so that the zone of the space covered by each of these sensors partially overlaps the zone of the space covered by the adjacent sensors.
   According to one or more embodiments of the invention, each individual sensor uses a frequency band that is different from that used by the adjacent sensors.
   According to one or more embodiments of the invention, each individual standalone sensor takes the measurement of the speed of the detected intruder by analyzing the doppler frequency of the echo corresponding to that intruder, and determines the angular position of the intruder.
   In a preferred embodiment, each sensor includes means for self-calibrating its measurements.
   In a preferred embodiment, each individual sensor includes transmission means for communicating with the adjacent sensors via radio link, and means for communicating with the central unit.
   In a preferred embodiment, each sensor includes means for determining its position relative to the adjacent sensors and certain sensors also include absolute positioning means of the GPS type.
   In a preferred embodiment, each sensor includes standalone means of power supply and storage.

The device according to one or more embodiments of the invention advantageously makes it possible to detect, monitor and classify individuals, animals and land vehicles which enter the protected zone and those which travel in this zone or leave it.

The detection information originating from the individual detection units is transmitted to a central system that is able to incorporate a man-machine interface. Moreover, it may advantageously be merged with other types of information relating for example to the presence and the movement in the protected zone of individuals or of authorized vehicles.

### DESCRIPTION OF THE FIGURES

The features and advantages of the invention will be better appreciated thanks to the following description, a description which, for greater clarity, explains the principle of the invention through nonlimiting exemplary embodiments. This description is also based on the appended figures which represent:

FIG. 1, the illustration of a first exemplary embodiment of the device according to the invention,

FIG. 2, the illustration of an exemplary embodiment of an individual sensor,

FIG. 3, an illustration of the operating principle of the device according to the invention, and

FIG. 4, the illustration of a second exemplary embodiment of the device according to the invention.

### DETAILED DESCRIPTION

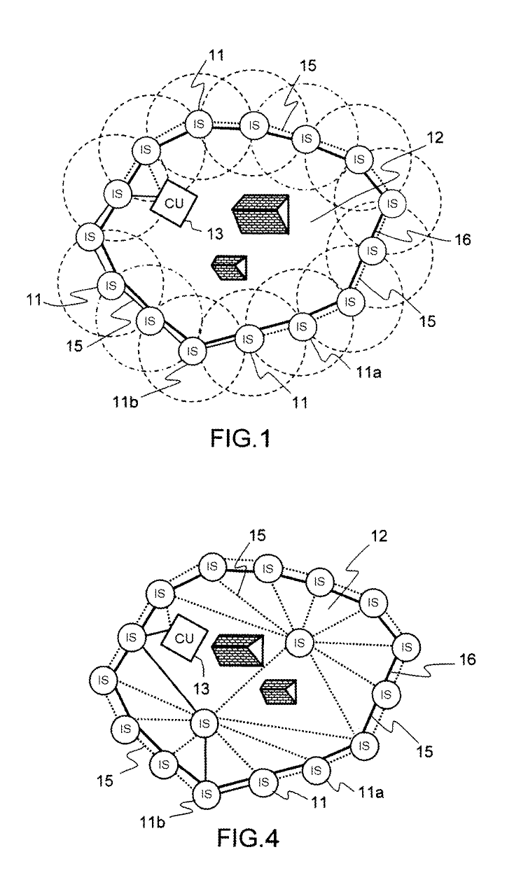

The illustration of FIG. 1 makes it possible to describe in a tangible manner the structure in principle of the device according to the invention. In the example of FIG. 1, the device according to the invention is configured so as to form a perimeter protection system. Accordingly, it includes a set of individual sensors 11 placed on the periphery of the zone 12 to be protected from intrusions.

Furthermore, one of the advantageous features of the device according to one or more embodiments of the invention lies in its ease of transport and deployment. For this, the device according to one or more embodiments of the invention has in particular a power consumption that is sufficiently low for its power supply not to pose a particular logistical problem. Accordingly, the individual sensors 11 are electromagnetic sensors and low-power communication systems whose range is limited.

When the device is deployed, the individual sensors are spaced out from one another at a distance d such that each individual sensor, covering a zone which extends around it, is situated just at the range limit of its closest neighbors 11a and 11b.

According to one or more embodiments of the invention, each individual sensor 11 is an electromagnetic Doppler sensor, of the rudimentary radar type, carrying out in a standalone manner the detection of any intruder, that is to say any individual, human being or animal, and any mobile machine attempting to enter the zone that it is responsible for guarding. In a standalone manner, it detects the intruder(s) and determines the speed and angular position of this intruder. Accordingly, it is configured so as to be able to take angular measurements in relative bearing and angle of elevation. The accuracy of the measurements, which vary depending on the method of determination used, is a function of the measurement means that the sensor has.

Therefore, any intruder attempting to cross the protection perimeter in order to enter the protected zone, or else to leave this zone, is advantageously detected by at least two consecutive sensors, each sensor independently taking the angular location and measuring the speed of the intruder. This dual or multiple action of location advantageously makes it possible to determine, by means of an appropriate geometric process, the position of the intruder at a given moment.

The device according to one or more embodiments of the invention also includes a central unit 13. The latter is responsible for merging the information originating from the various sensors 11 and for determining the corresponding position of the intruder. Accordingly, each sensor 11 which detects an intruder retransmits the angular location and speed information to the central unit 13.

In this way, knowing the position and orientation of each sensor, the central unit can, for a certain distance depending on the range of each sensor 11 and on the geometry of the protected zone 13, track the change in the position of the intruder and determine its probable trajectory inside the zone. Similarly, knowing the position of each sensor 11 along the protection perimeter, the central unit 13 is advantageously capable of determining, with an accuracy corresponding to the distance between sensors, the point of entry of the intruder into the zone.

In a preferred embodiment, such as that illustrated by FIG. 1, the sensors 11 are placed in a substantially equidistant manner along the perimeter 16, shown as a solid line, surrounding the protected zone. Each sensor covers a zone 14 extending all around it, with an angular aperture in angle of elevation that allows it to detect both land-based intruders and machines flying at low or very low altitude, typically an aperture in angle of elevation of approximately 15° to 20°. According to this preferred embodiment, the range of each sensor is of the order of from 100 to several hundred meters.

According to one or more embodiments of the invention, each sensor 11 which detects an intruder transmits directly to the central unit 13, or to the central unit via the communication network formed by the other sensors, the angular position and relative speed information of this intruder. The transmission of this information is preferably carried out by radio communication according to a standard or secure communication protocol depending on the case. Radio communication between the individual receivers 11 and the central unit 13 advantageously makes it easier to deploy the device on the ground and retrieve it later.

According to one or more embodiments of the invention, the information relating to an intruder detected by a given sensor is not automatically communicated directly between this sensor and the central unit. Specifically, each sensor 11, for the reasons of space requirement and power consumption specified previously, has radio communication means of limited power whose range may be, depending on the position of the sensor along the perimeter, less than the distance that separates this sensor from the central unit 13. Direct communication may therefore not always be established. That is why the device according to the invention advantageously uses a communication method according to which the information originating from a given sensor is relayed step by step from one sensor 11 to its neighbours 11a and 11b until it reaches the central unit. This gives a mesh communication network 15 which transfers the information to the central unit 13. From an operational point of view, the communication protocol used makes it possible, after an initialization phase, to determine the most appropriate communication channel for each sensor in order to transmit the information to the central unit. This channel takes the form, for example, of the list of the identifiers of the sensors which will successively relay the information from a given sensor to the central unit. As illustrated by the example of the figure, a succession of meshes (meshes in solid lines passing through the sensor 11a) amongst all the possible meshes is preferred for each sensor 11.

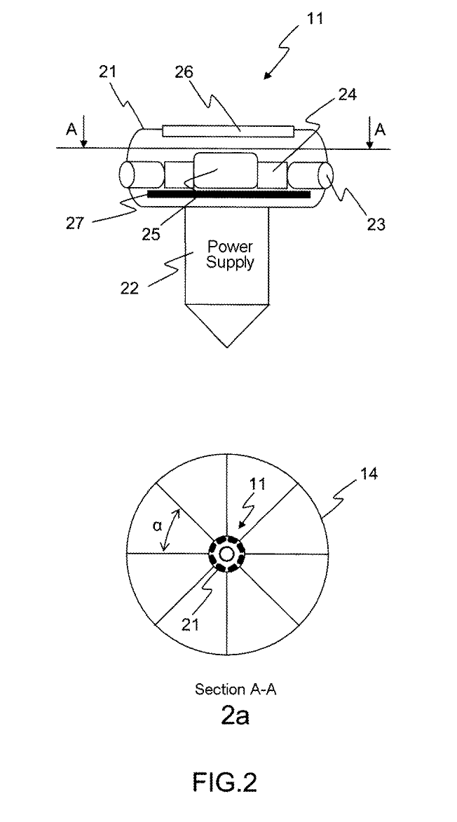

FIG. 2 presents in a schematic manner the structure of an individual sensor according to one or more embodiments of the invention. As the figure illustrates, each individual sensor includes mainly a top portion 21 in the shape of a circular casing of modest size, with a diameter of approximately twenty centimeters and a height of a few centimeters for example, and an inner portion 22 having the shape of a hollow spike designed to be inserted into the ground so as to hold the sensor 11 in a fixed and stable position, the upper portion 21 remaining on the surface.

According to one or more embodiments of the invention, the upper portion 21 mainly includes the following elements:
A set of antennae 23 placed, as illustrated in the view 2-a, on the periphery of the sensor, each antenna having a diagram allowing it to cover an angular sector α. Because of the value of this angle α, the sensor according to one or more embodiments of the invention includes a number of antennae such that the totality of the surveillance zone 14 assigned to the sensor is covered. The angle α is furthermore determined according to the desired accuracy on the determination of the angular position of the detected intruder via the signal received by one of the antennae of the sensor.
A set of transceiver elements 24 including means for generating microwaves and means for receiving the echoes received at each antenna. In an alternative embodiment, the sensor may include only one transceiver element which is then associated with a switching (matrix) device, a matrix which alternately switches the transceiver element to each of the antennae:
digital means 25 capable of performing the functions of processing the signal and of processing the data relating to the detection of the intruders, and the functions relating to the management of communications with the other sensors and with the central unit,
means for allowing the sensor to determine its position and its orientation relative to north, this orientation being determined with the aid of an electronic compass or any other appropriate means.
   According to the chosen embodiment, the sensor according to the invention has more or less standalone means for determining its geographic position. Each sensor forming part of the device according to one or more embodiments of the invention may therefore, for example, include absolute positioning means of the GPS type. Alternatively, the device according to one or more embodiments of the invention may include only a few reference sensors including absolute positioning means, the rest of the sensors including only relative positioning means by location of the adjacent sensors:
radio transmission means allowing each sensor to establish a direct communication with the adjacent sensors and/or with the central unit. Because these radio transmission means have a relatively short range with respect to the dimensions of the surface area to be protected, only the sensors closest to the central unit are capable of entering into direct communication with it, the other sensors being limited to the step-by-step communication method described above,
a printed circuit 27 which is used to interconnect the various elements and to transmit the low-frequency electric, radiofrequency and microwave signals and as the mechanical support for these various elements.

According to one or more embodiments of the invention, the lower portion 22 for its part includes mainly power supply means, batteries for example.

In a preferred embodiment, the sensor also includes means 26 for recharging in a standalone manner the batteries supplying the electric power to the sensor. These means includes for example a set of photovoltaic cells installed on the upper surface of the upper portion 21 and recharging the batteries housed in the lower portion 22. In this way, the sensor advantageously has complete power supply autonomy and is capable of functioning virtually indefinitely.

For certain particular applications, the sensor 11 may also be furnished with additional means such as seismic sensors used in particular for detecting attempts to pull out of the ground and disable the sensor.

Therefore, through the compact structure and small size of the sensors 11 on the one hand, and through their total autonomy of operation on the other hand, and through the flexibility of the system of communication between the sensors and the central unit furthermore, the device according to one or more embodiments of the invention advantageously has a structure that is light, easily deployable and requires no particular logistics. Although it may be used in all the circumstances requiring the installation of a security perimeter, it is particularly suited to the rapid protection of sensitive zones or danger zones.

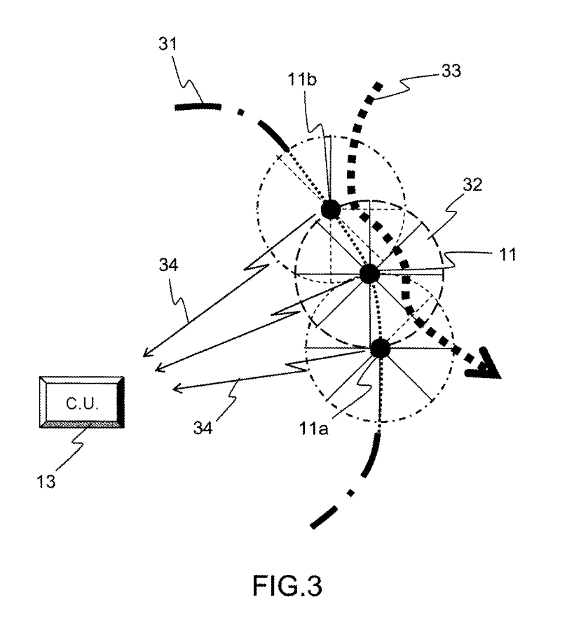

With respect to the operating principle of the device according to the invention, the latter can be described with reference to FIG. 3.

The implementation on the ground of the device according to the invention includes several phases. There is therefore:
a deployment phase,
an initialization phase,
an operational phase.

The deployment phase includes placing, on a perimeter 31 surrounding the zone 12 to be protected, all of the sensors 11 with a spacing between two sensors defined so that each sensor 11 is positioned inside the zones covered by the two adjacent sensors 11a, 11b. Each sensor is placed in the location desired by an operator who sticks the lower portion 22 of the sensor in the ground. In this way, the latter is naturally held in position. It is then for example switched on in a state awaiting the initialization step.

The initialization phase allows the device to be placed in operational service. During this phase, each sensor notably transmits to the central unit the information relating to its position (the relative or absolute position depending on the case) and to its orientation relative to north. During this phase, the central unit also determines, for each sensor 11 that is too far away to communicate with it directly, the identifier of the adjacent sensor 11a or 11b chosen to relay its information.

The operational phase represents the actual surveillance phase. During this phase, each sensor 11 monitors the zone 14 for which it is responsible, a zone divided into angular sectors 32 with an aperture α. Subsequently, when an intrusion is detected in a given location of the perimeter 31, each of the sensors concerned transmits periodically to the central unit 13, via a direct radio link or relayed via the network of individual sensors, the link symbolized by the broken arrows 34 in the figure, an item of alert information and the successive measurements relating to the intrusion, namely the angular sector in which the intruder has been detected by the current measurement and the speed of progress. The central unit 13 then uses these data by linking together the data supplied by the various sensors and considered to relate to one and the same intruder and determines by goniometry, based on the successive refreshes of the information, the positions occupied successively by the intruder since the time of alert. The central unit is therefore capable of determining the initial trajectory of the intruder in the protected zone.

In addition, because, as illustrated in FIG. 3, each sensor monitors a zone situated on either side of the protection perimeter 31, a preliminary intrusion alarm may be generated by the central unit as soon as a potential intruder enters the zone covered by the sensor. In this way, the central unit 13 may advantageously monitor the trajectory 33 of a potential intruder moving outside the protected zone and anticipate a possible intrusion.
Depending on the type of protection envisaged for the zone in question, the central unit 13 may be an entirely automatic system capable of transmitting the information relating to the movements of the intruder to a command post or else a standalone unit provided with a man-machine interface allowing an operator to decide on site what action to take with respect to the intrusion.

As has been said in the foregoing, the device according to the invention makes it possible to simply deploy a barrier making it possible to detect crossing by intruders (people, animals or vehicles) of a guarded perimeter, and to do so whether they are entering or leaving: Advantageously, this barrier makes it possible not only to detect the intrusion, but also to prevent a possible incursion. It also makes it possible to determine, over a certain distance, the trajectory of the intruder inside the protected zone. However, when necessary, it is advantageously possible, as illustrated in FIG. 4, to deploy the device according to the invention not only so as to simply form a barrier, but so as to also carry out monitoring of the protected zone, the deployment resulting therefrom furthermore in no way modifying the functional features or the operating principle of the device according to the invention.

In this particular embodiment, the individual sensors 11 are deployed not only on the periphery of the protected zone but also inside this zone. In this way, the meshing thus produced covering the whole of the protected zone, it is possible, as soon as one (or more) intruders has (have) been detected by the peripheral sensors, to determine at any time its (their) position(s) in the zone, its (their) trajectory/ies and its (their) speed of progression.
The applications of the device according to the invention are naturally many in number. In particular, the possibility of having access to the knowledge of the position of the intruder via a goniometric method makes it possible to envisage complex systems. It is possible, for example, to use a device according to the invention the central unit of which includes a man-machine interface allowing the operator to define, in an open-ended manner inside a protected zone, particular temporary exclusion zones which should in no circumstances, at given times and for determined periods, be entered. Such a configuration is particularly useful for a complex urban environment where potential intruders may move around amongst a large number of individuals moving in the zone out of necessity and in which the repetitive installation and removal of physical barriers are difficult to envisage.
Amongst the possible applications of the device according to the invention it is naturally possible to cite in a nonexhaustive manner:
the monitoring of frontiers, airport tarmac, beaches,
the monitoring of critical infrastructures: chemical and nuclear plants, water treatment plants, airports, etc.,
the monitoring of railway tracks, oil pipelines, gas pipelines,
the monitoring of private goods: monitoring of gardens,
the management of exclusion zones during chemical or health
incidents,
the detection of the approach of supertankers in port zones,
the monitoring of drilling platforms,
the detection of intrusion into or attempted escapes from detention
centers,
the monitoring of military zones and camps,
the monitoring of aircraft on the ground.

1. A device for detecting movements into a guarded zone or out of the guarded zone, comprising:
a plurality of individual standalone electromagnetic sensors, placed on a perimeter of the guarded zone and arranged so that a space covered by each sensor partially overlaps a space covered by another sensor; and
a central unit, the central unit in communication with at least one of the plurality of sensors;
wherein each sensor takes a measurement of an angular position and of a speed of an intruder present in the respective space that the sensor covers, the measurement being relayed to the central unit from the sensor that detected the intruder, by successive transmissions of the measurements from one sensor to a next sensor adjacent to the one sensor or, for a sensor sufficiently close to the central unit, from the sensor sufficiently close to the central unit to the central unit; in order for the central unit to calculate periodically a position and a trajectory of the detected intruder by use of measurements transmitted by the plurality of sensors.

2. The device as claimed in claim 1, further comprising individual standalone electromagnetic sensors located inside the guarded zone and also arranged so that a space covered by each sensor located inside the guarded zone partially overlaps a space covered by another sensor.

3. The device as claimed in claim 1, wherein each individual sensor uses a frequency band that is different from a frequency band used by adjacent sensors.

4. The device as claimed in claim 1, wherein each individual standalone sensor takes the measurement of the speed of the detected intruder by analyzing a Doppler frequency of an echo corresponding to that intruder.

5. The device as claimed in claim 1, wherein each sensor comprises a circuit to self-calibrate its measurements.

6. The device as claimed in claim 1, wherein each individual sensor comprises a transmitter to communicate with the adjacent sensors via wireless communication, and a transmitter to communicate with the central unit.

7. The device as claimed in claim 1, wherein each sensor comprises a circuit to determine its position relative to the adjacent sensors.

8. The device as claimed in claim 7, wherein predetermined individual sensors comprise a GPS position locator.

9. The device as claimed in claim 1, wherein each sensor further comprises a standalone power-supply.
